(19) United States
(12) Patent Application Publication
(10) Pub. No.: US 2020/0402076 A1
(43) Pub. Date: Dec. 24, 2020

(54) DATA PROCESSING METHOD AND APPARATUS, AND STORAGE MEDIUM

(71) Applicant: BEIJING SENSETIME TECHNOLOGY DEVELOPMENT CO., LTD., Beijing (CN)

(72) Inventors: Guojin ZHANG, Beijing (CN); Wenhao DING, Beijing (CN); Yuting GAO, Beijing (CN); Chen CHEN, Beijing (CN); Yan WANG, Beijing (CN); Mingyang ZHANG, Beijing (CN)

(21) Appl. No.: 17/015,444

(22) Filed: Sep. 9, 2020

Related U.S. Application Data
(63) Continuation of application No. PCT/CN2020/090086, filed on May 13, 2020.

(30) Foreign Application Priority Data
Jun. 3, 2019 (CN) 201910478689.1

(51) Int. Cl. G06Q 30/02; G06K 9/00; G06K 9/62

(52) U.S. Cl. CPC G06Q 30/0201; G06K 9/00671; G06K 9/6202; G06K 9/00362

(57) ABSTRACT

A data processing method and apparatus, and a storage medium are provided. The data processing method includes that: image identification processing is performed on an acquired image to obtain person identity information of a person included in the image; historical visiting information corresponding to the person identity information is acquired; visiting frequency information of the person is determined according to the historical visiting information corresponding to the person identity information; and label information of the person is determined based on the visiting frequency information of the person.

### CROSS-REFERENCE TO RELATED APPLICATION

This application is a continuation application of International Patent Application No. PCT/CN2020/090086, filed on May 13, 2020, which claims priority from Chinese patent application No. 201910478689.1, filed on Jun. 3, 2019. The disclosures of International Patent Application No. PCT/CN2020/090086 and Chinese patent application No. 201910478689.1 are hereby incorporated by reference in their entireties.

### BACKGROUND

In practical use, a salesman welcomes customers differently according to features of the customers, so as to improve the sales conversion rate and achieve better benefit. However, how to obtain information useful to evaluate the value of the customer through plentiful and complicated visiting information is very difficult.

### SUMMARY

The present disclosure relates to computer vision technologies, and particularly, to a data processing method and apparatus, and storage medium.

In view of this, embodiments of the present disclosure provide a data processing solution.

In a first aspect, the embodiments of the present disclosure provide a data processing method, which may include that: image identification processing is performed on an acquired image to obtain person identity information of a person included in the image; historical visiting information corresponding to the person identity information is acquired; visiting frequency information of the person is determined according to the historical visiting information corresponding to the person identity information; and label information of the person is determined based on the visiting frequency information of the person.

In a possible implementation, the operation that the historical visiting information corresponding to the person identity information is acquired may include that: an identity type corresponding to the person identity information is determined, the identity type including at least one of a member or a customer; and the historical visiting information corresponding to the person identity information is acquired based on the identity type corresponding to the person identity information.

In a possible implementation, the operation that the historical visiting information corresponding to the person identity information is acquired based on the identity type corresponding to the person identity information may include that: in response to that the identity type of the person is the customer, historical visiting information of the person, who corresponds to the person identity information, at a current visiting place is acquired.

In a possible implementation, the operation that the historical visiting information corresponding to the person identity information is acquired based on the identity type corresponding to the person identity information may include that: in response to that the identity type of the person is the member, historical visiting information of the person, who corresponds to the person identity information, in at least a part of places in a set to which a current visiting place belongs is acquired.

In a possible implementation, the visiting frequency information of the person includes at least one of: the number of visiting times of the person within a preset time period and a time interval between the latest visiting time of the person and current time.

In a possible implementation, the operation that the label information of the person is determined based on the visiting frequency information of the person may include that: in response to that the number of visiting times of the target person within the preset time period is greater than or equal to a first threshold, it is determined that the label information of the target person indicates a high frequency.

In a possible implementation, the operation that the label information of the person is determined based on the visiting frequency information of the person may include that: the label information of the person is determined based on the visiting frequency information of the person and the identity type of the person.

In a possible implementation, the operation that the label information of the person is determined based on the visiting frequency information of the person and the identity type of the person may include that: in response to that the time interval between the latest visiting time of the person and the current time exceeds a second threshold, the label information of the person is determined based on the visiting frequency information of the person and the identity type of the person.

In a possible implementation, the operation that the label information of the person is determined based on the visiting frequency information of the person and the identity type of the person may include that: in response to that the time interval between the latest visiting time of the person and the current time exceeds the second threshold and the identity type of the person is the customer, it is determined that the label information of the person indicates a loss; and/or, in response to that the time interval between the latest visiting time of the person and the current time exceeds the second threshold and the identity type of the person is the member, it is determined that the label information of the person indicates a deep sleep.

In a possible implementation, before the historical visiting information corresponding to the person identity information is acquired, the method may further include that: whether the historical visiting information corresponding to the person identity information is acquired within a second preset time period of the person is determined; if yes, the historical visiting information corresponding to the person identity information is no longer acquired within the second preset time period; and if no, the historical visiting information corresponding to the person identity information is acquired.

In a possible implementation, the method may further include that: input label edition information is acquired, the label being user-defined; and a label set in an underlying database is adjusted based on the label edition information.

In a possible implementation, before the visiting frequency information of the person is determined according to the historical visiting information corresponding to the person identity information, the method may further include that: duplication eliminating processing is performed on the person identity information; and the operation that the visiting frequency information of the person is determined according to the historical visiting information corresponding to the person identity information may include that: the visiting frequency information of the person is determined according to historical visiting information corresponding to person identity information that is obtained by the duplication eliminating processing.

In a possible implementation, the operation that the image identification processing is performed on the acquired image to obtain the person identity information of the person included in the image may include that: the acquired image is processed to determine whether the underlying database includes an image template matching with the person included in the image; and in response to that the underlying database has the image template matching with the person, person identity information corresponding to the matched image template is taken as the person identity information of the person.

In a possible implementation, the method may further include that: in response to that the underlying database does not have the image template matching with the person, an image template corresponding to the person is created in the underlying database, and a new person identity is allocated to the person.

In a possible implementation, the method may further include that: the label information of the person is sent to a terminal device, such that the terminal device displays the label information of the person.

In a second aspect, the embodiments of the present disclosure further provide a data processing method, which is applied to a terminal and may include that: label information of a visiting person that is sent by a server is received; and the label information of the person is displayed, the label information of the person being obtained by the server based on visiting frequency information of the person.

In a possible implementation, the operation that the label information of the person is displayed may include that: the label information of the person is displayed in a visiting notification interface for the person.

In a third aspect, the embodiments of the present disclosure further provide a data processing apparatus, which may include: an image identification module, configured to perform image identification processing on an acquired image to obtain person identity information of a person included in the image; an acquisition module, configured to acquire historical visiting information corresponding to the person identity information; a first determination module, configured to determine visiting frequency information of the person according to the historical visiting information corresponding to the person identity information; and a second determination module, configured to determine label information of the person based on the visiting frequency information of the person.

In a possible implementation, the acquisition module may include: a determination unit, configured to determine an identity type corresponding to the person identity information, the identity type including at least one of a member or a customer; and an acquisition unit, configured to acquire the historical visiting information corresponding to the person identity information based on the identity type corresponding to the person identity information.

In a possible implementation, the acquisition unit is configured to: acquire, in response to that the identity type of the person is the customer, historical visiting information of the person, who corresponds to the person identity information, at a current visiting place.

In a possible implementation, the acquisition unit is configured to: acquire, in response to that the identity type of the person is the member, historical visiting information of the person, who corresponds to the person identity information, in at least a part of places in a set to which a current visiting place belongs.

In a possible implementation, the visiting frequency information of the person includes at least one of: the number of visiting times of the person within a preset time period and a time interval between the latest visiting time of the person and current time.

In a possible implementation, the second determination module is configured to: determine, in response to that the number of visiting times of the target person within the preset time period is greater than or equal to a first threshold, that the label information of the target person indicates a high frequency.

In a possible implementation, the second determination module is configured to: determine the label information of the person based on the visiting frequency information of the person and the identity type of the person.

In a possible implementation, the second determination module is configured to: determine, in response to that the time interval between the latest visiting time of the person and the current time exceeds a second threshold, the label information of the person based on the visiting frequency information of the person and the identity type of the person.

In a possible implementation, the second determination module is configured to: determine, in response to that the time interval between the latest visiting time of the person and the current time exceeds the second threshold and the identity type of the person is the customer, that the label information of the person indicates a loss; and/or, determine, in response to that the time interval between the latest visiting time of the person and the current time exceeds the second threshold and the identity type of the person is the member, that the label information of the person indicates a deep sleep.

In a possible implementation, the apparatus may further include: a duplication eliminating module, configured to perform duplication eliminating processing on the person identity information before the second determination module determines the visiting frequency information of the person according to the historical visiting information corresponding to the person identity information; and the second determination module is configured to: determine the visiting frequency information of the person according to historical visiting information corresponding to person identity information that is obtained by the duplication eliminating processing.

In a possible implementation, the image identification module is configured to: process the acquired image to determine whether an underlying database includes an image template matching with the person included in the image, and take, in response to that the underlying database has the image template matching with the person, person identity information corresponding to the matched image template as the person identity information of the person.

In a possible implementation, the image identification module is configured to: create, in response to that the underlying database does not have the image template matching with the person, an image template corresponding to the person in the underlying database, and allocate a new person identity to the person.

In a possible implementation, the apparatus may further include: a communication module, configured to send the label information of the person to a terminal device, such that the terminal device displays the label information of the person.

In a possible implementation, the acquisition module is further configured to: determine, before acquiring the historical visiting information corresponding to the person identity information, whether the historical visiting information corresponding to the person identity information is acquired within a second preset time period of the person; no longer acquire, if yes, the historical visiting information corresponding to the person identity information within the second preset time period; and acquire, if no, the historical visiting information corresponding to the person identity information.

In a possible implementation, the apparatus may further include: a setting module, configured to acquire input label edition information, the label being user-defined; and adjust a label set in the underlying database based on the label edition information.

In a fourth aspect, the embodiments of the present disclosure further provide a data processing apparatus, which is applied to a terminal and may include: a receiving module, configured to receive label information of a visiting person that is sent by a server; and a display module, configured to display the label information of the person, the label information of the person being obtained by the server based on visiting frequency information of the person.

In a possible implementation, the display module is configured to: display the label information of the person in a visiting notification interface for the person.

In a fifth aspect, the embodiments of the present disclosure provide a data processing apparatus, which may include: a memory, a processor, and a computer program stored on the memory and capable of running on the processor; and the processor implements, when executing the program, steps of the data processing method in the embodiments of the present disclosure.

In a sixth aspect, the embodiments of the present disclosure provide a storage medium; the storage medium stores a computer program; and the computer program causes, when executed by a processor, the processor to execute the steps of the data processing method in the embodiments of the present disclosure.

In a seventh aspect, the embodiments of the present disclosure provide a computer program, which may include a computer-readable code; and when the computer-readable code runs in an electronic device, a processor in the electronic device executes the data processing method in the embodiments of the present disclosure.

According to the technical solutions provided by the embodiment of the present disclosure, the image identification processing is performed on the acquired image to obtain the person identity information of the person included in the image; the historical visiting information corresponding to the person identity information is acquired; the visiting frequency information of the person is determined according to the historical visiting information corresponding to the person identity information; and the label information of the person is determined based on the visiting frequency information of the person. Therefore, the present disclosure is convenient to provide a targeted service for a customer based on a label of the customer, thereby improving the customer experience and the sales conversion rate.

It is to be understood that the above general descriptions and detailed descriptions below are only exemplary and explanatory and not intended to limit the disclosure.

According to the following detailed descriptions on the exemplary embodiments with reference to the accompanying drawings, other characteristics and aspects of the disclosure become apparent.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a first flowchart schematic diagram of a data processing method provided by an embodiment of the present disclosure.

FIG. 2 is a second flowchart schematic diagram of a data processing method provided by an embodiment of the present disclosure.

FIG. 3 is an exemplary architecture schematic diagram of a data processing system to which an embodiment of the present disclosure is applied.

FIG. 4 is a flowchart schematic diagram illustrating that a personnel label is analyzed based on the number of visiting times provided by an embodiment of the present disclosure.

FIG. 5(a) is a schematic diagram illustrating that a terminal receives a visiting message for pushing provided by an embodiment of the present disclosure. FIG. 5(b) is a schematic diagram illustrating that a historical visiting message of a consumer is queried provided by an embodiment of the present disclosure. FIG. 5(c) is a schematic diagram illustrating that a system displayed at a terminal side automatically identifies a multidimensional identity label provided by an embodiment of the present disclosure.

FIG. 5(d) is a data analysis schematic diagram obtained by a visiting person in a time period provided by an embodiment of the present disclosure.

FIG. 6 is a schematic diagram of an edit interface of a personnel label provided by an embodiment of the present disclosure.

FIG. 7 is a first compositional structural schematic diagram of a data processing apparatus provided by an embodiment of the present disclosure.

FIG. 8 is a second compositional structural schematic diagram of a data processing apparatus provided by an embodiment of the present disclosure.

FIG. 9 is an interaction schematic diagram between a server and a terminal device provided by an embodiment of the present disclosure.

### DETAILED DESCRIPTION

Various exemplary embodiments, features and aspects of the disclosure will be described below in detail with reference to the accompanying drawings. A same numeral in the accompanying drawings indicates a same or similar component. Although various aspects of the embodiments are illustrated in the accompanying drawings, the accompanying drawings are unnecessarily drawn according to a proportion unless otherwise specified.

As used herein, the word “exemplary” means “serving as an example, instance, or illustration”. Thus, any embodiment described herein as “exemplary” is not necessarily to be construed as preferred or advantageous over other embodiments.

The term “and/or” herein is only an association relationship for describing associated objects, and represents that three relationships may exist, for example, a and/or b may represent that: a exists alone, a and a exist at the same time, and b exists alone. In addition, the term “at least one type” herein represents any one of multiple types or any combination of at least two types in the multiple types, for example, at least one type of a, b and c may represent any one or multiple elements selected from a set formed by the a, the b and the c.

Additionally, in order to better describe the embodiments of the disclosure, numerous specific details are given in the detailed description below. It is to be understood by those skilled in the art that the embodiments of the disclosure may also be implemented without some specific details. In some examples, the method, means, element and circuit familiar to those skilled in the art are not described in detail so as to embody the tenet of the embodiments of the disclosure.

It is to be understood that the method embodiments mentioned in the disclosure may be combined with each other to form a combined embodiment without departing from the principle and logic, which is not elaborated in the embodiments of the disclosure for the sake of simplicity.

To make those skilled in the art to better understand the solutions in the embodiments of the present disclosure, the following clearly describes the technical solutions in the embodiments of the present disclosure with reference to the accompanying drawings in the embodiments of the present disclosure. Apparently, the described embodiments are a part rather than all of the embodiments of the present disclosure.

The terms such as “first”, “second” and “third” in the embodiments of the specification, claims and accompanying drawings of the present disclosure are only used to distinguish similar objects, rather than to describe a special order or a precedence order. In addition, the terms “comprise,” “comprising,” “include,” “including,” “has,” “having” or any other variation thereof, are intended to cover a non-exclusive inclusion. For example, a method, system, product or device that includes a list of steps or units is not necessarily limited to only those steps or units but may include other steps or units not expressly listed or inherent to such method, product or device.

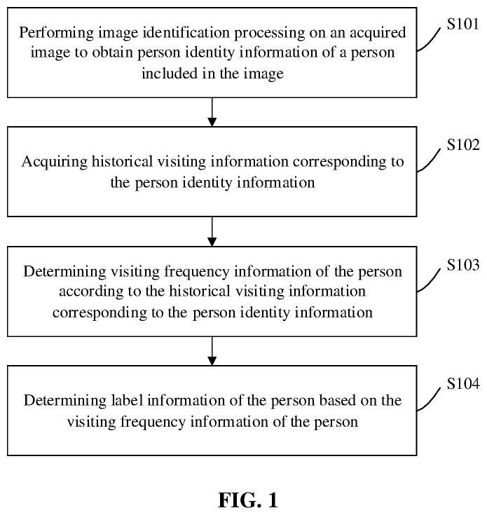

The embodiments of the present disclosure provide a data processing method, which is applied to a server or other electronic devices. The server may be a cloud server or an ordinary server. The electronic device may be User Equipment (UE), a mobile device, a user terminal, a cell phone, a cordless phone, a Personal Digital Assistant (PDA), a handheld device, a computing device, a vehicle-mounted device, a wearable device, etc. As shown in FIG. 1, the method may include the following steps.

In S101, image identification processing is performed on an acquired image to obtain person identity information of a person included in the image.

Herein, the image is obtained by collecting with an image collector having an image collection function such as a Webcam or a camera, and may also be an image received by a communicator, or an image read locally and directly. The acquisition manner is not limited in the embodiment of the present disclosure.

In the embodiment of the present disclosure, the image may be acquired through a variety of manners, for example, the image collected by the image collector may be received, or the image transmitted by other device may be received by using the communicator, and the image may further be stored locally in advance such that the image is read locally when used in necessary.

In the embodiment of the present disclosure, the person identity information is configured to distinguish identities of different persons, like numbers or Identity Documents (IDs). Different persons correspond to different identities.

It is to be noted that different IDs are allocated to different persons, each visiting person is allocated with one person identity, and merely one person identity is allocated to the same person.

In some optional embodiments, the operation that the image identification processing is performed on the acquired image to obtain the person identity information of the person included in the image may include the following operations.

The acquired image is processed to determine whether an underlying database includes an image template matching with the person included in the image.

In response to that the underlying database has the image template matching with the person, person identity information corresponding to the matched image template is taken as the person identity information of the person.

In some optional embodiments, the acquired image may be compared with the image template stored in the underlying database to determine whether the underlying database includes the image template matching with the image. The image template of the underlying database may include image and/or feature information. The feature information may include a face feature and/or a body feature and is not limited thereto in the embodiment of the disclosure.

The person included in the image may be understood as a visiting person.

In some optional implementations, the image template includes at least one of the face feature and the body feature of the person. Correspondingly, the operation that whether the underlying database includes the image template matching with the person included in the image is determined may include the following operations.

A face feature and/or a body feature of the person included in the image is extracted.

Whether the underlying database has an image template matching with the face feature and/or the body feature is determined.

In one example, with the face feature as the example, a similarity between the face feature of the image and a reference face feature included in at least one image template stored in the underlying database may be determined, and whether the underlying database has the image template matching with the image is determined based on whether a similarity in the obtained similarities reaches a preset threshold. However, the embodiment of the disclosure is not limited thereto.

In some examples, the method may further include the following operation.

In response to that the underlying database does not have the image template matching with the person, an image template corresponding to the person is created in the underlying database, and new person identity information is allocated to the person.

Therefore, the data in the underlying database is supplemented by recording visiting information of a new customer (i.e., a new visiting person), to facilitate subsequent query when the new customer visits again.

In some optional embodiments, the operation that the image identification processing is performed on the acquired image may include the following operations.

A position where a face and/or a body in the image is located is determined.

Face feature extraction processing is performed on the position where the face is located in the image, and/or body feature extraction processing is performed on the position where the body is located.

A face feature identification result is obtained according to the face feature extraction processing, and/or a body feature identification result is obtained according to the body feature extraction processing.

In some embodiments, the image identification processing is performed on the acquired image through a face identification technology to obtain the face feature identification result of the image. The face identification technology is not specifically limited in the present disclosure.

In some embodiments, the image identification processing is performed on the acquired image through a body identification technology to obtain the body feature identification result of the image. The body identification technology is not specifically limited in the present disclosure.

In some optional embodiments, the operation that the image identification processing is performed on the acquired image to obtain the person identity information of the person included in the image may include the following operation.

According to a face feature and/or body feature identification result obtained by image identification processing, whether person identity information matching with the face feature and/or body feature identification result exists is determined.

In some examples, the underlying database is searched based on the face feature and/or body feature identification result to search whether the underlying database has the face feature and/or body feature identification result; and when the face feature and/or body feature identification result is searched, the person identity information corresponding to the face feature and/or body feature identification result is acquired.

It is to be noted that visiting record information of historical visiting people is stored in the underlying database, and the visiting record information at least includes a face feature and/or body feature image, personal ID information and visiting time information.

It is to be noted that each visiting person is allocated with one person identity, and merely one person identity is allocated to the same person.

Therefore, whether a current visiting person is a new customer or an old customer is determined by determining whether the person identity information matching with the face feature and/or body feature identification result exists.

In S102, historical visiting information corresponding to the person identity information is acquired.

In some optional embodiments, the operation that the historical visiting information corresponding to the person identity information is acquired may include the following operation.

Based on the person identity information, the historical visiting information corresponding to the person identity information is queried in the underlying database.

Herein, the historical visiting information at least includes visiting time.

It is to be noted that the historical visiting information may be all visiting information before the visiting at the current time. Certainly, the historical visiting information may further be visiting information within a certain time period towards the visiting at the current time, and the certain time period may be set or adjusted according to a design requirement. Or, the historical visiting information may further be a part of all visiting information before the visiting at the current time, for example, a part of all visiting information is selected according to a preset frequency, or a part of all visiting information is randomly selected. Certainly, in addition to selection on a time sequence, a screening manner in other dimensionalities may further be used to acquire a part of all visiting information. Other dimensionalities refer to factors that may be directly or indirectly determined from the visiting information such as a store type, and is not limited thereto.

In some optional embodiments, the historical visiting information may further include at least one of: visiting place information or a visiting store, payment and purchase information, a stay duration, a consultation duration, a purchase intention, etc. Herein, the stay time refers to the stay duration of the customer in the store.

It is to be noted that details of the historical visiting information are not limited in the present disclosure. The more detailed historical visiting record is more favorable to explore a high-value customer subsequently.

Therefore, the high-value customer is analyzed conveniently according to the historical visiting information.

In some optional embodiments, the operation that the historical visiting information corresponding to the person identity information is acquired may include the following operations.

An identity type corresponding to the person identity information is determined, the identity type including at least one of a member or a customer.

The historical visiting information corresponding to the person identity information is acquired based on the identity type corresponding to the person identity information.

In some optional implementations, the operation that the identity type corresponding to the person identity information is determined may include the following operation.

The identity type is determined based on identity type information carried in the person identity information.

Exemplarily, in the underlying database, the person identity information carries the identity type information, and different identity types are represented by different symbols in the person identity information; and the identity type corresponding to the person identity information is determined by distinguishing the symbols.

For example, the tail of the person identity information is attached with an A or B character; when the tail of the person identity information is provided with the A character, it is determined that the identity type corresponding to the person identity information is the member; and when the tail of the person identity information is provided with the B character, it is determined that the identity type corresponding to the person identity information is the customer.

In some optional implementations, when the identity type is the member, the historical visiting information corresponding to the person identity information is acquired from a first database of the underlying database.

In some optional implementations, when the identity type is the customer, the historical visiting information corresponding to the person identity information is acquired from a second database of the underlying database.

Therefore, the underlying database stores the visiting information of the member and the customer respectively, and first analyzes the identity type of the visiting person and then queries the historical visiting information of the visiting person from the corresponding database of the underlying database pointedly.

In some optional embodiments, the operation that the historical visiting information corresponding to the person identity information is acquired based on the identity type corresponding to the person identity information may include the following operation.

In response to that the identity type of the person is the customer, historical visiting information of the person, who corresponds to the person identity information, at a current visiting place is acquired.

In some optional embodiments, the operation that the historical visiting information corresponding to the person identity information is acquired based on the identity type corresponding to the person identity information may include the following operation.

In response to that the identity type of the person is the member, historical visiting information of the person, who corresponds to the person identity information, in at least a part of places in a set to which a current visiting place belongs is acquired.

For example, the A company has x branches that are respectively recorded as a1, a2, . . . , ax, and an employee A of the A company works in the a1 branch. When the employee A appears in the a2 branch for the first time, the employee A is not considered as the new customer. As the employee A is the employee of the A company, the employee A is considered as the member, and the employee A is analyzed by acquiring all historical visiting information of the employee A in the A company, such as by analyzing a card attendance condition of the employee A.

Also for example, the cake chain store B has eight stores, and the person B is registered as the member in one store. When the person B appears in other seven stores, the person B is considered as the old customer rather than the new customer. Whether the person B is expected to become a senior member defined by the cake chain store is analyzed by analyzing the presence in the eight stores.

In a possible implementation, before the historical visiting information corresponding to the person identity information is acquired, the method may further include the following operation.

Whether the historical visiting information corresponding to the person identity information is acquired within a second preset time period of the person is determined; if yes, the historical visiting information corresponding to the person identity information is no longer acquired within the second preset time period; and if no, the historical visiting information corresponding to the person identity information is acquired.

Herein, the second preset time period may be set or adjusted as required. For example, the second preset time period is set as 1 day. That is, for the same visiting person who comes for multiple times within one day, the label is processed only once.

In S103, visiting frequency information of the person is determined according to the historical visiting information corresponding to the person identity information.

In a possible implementation, the visiting frequency information of the person includes at least one of: the number of visiting times of the person within a preset time period and a time interval between the latest visiting time of the person and current time.

As an implementation, the visiting frequency information of the person includes: the number of visiting times of the person within the preset time period.

Therefore, the visiting frequency is characterized by the number of visiting times of the person within the preset time period. Exemplarily, if the number of visiting times of a customer A within the preset time period is y, the visiting frequency of the customer A is y.

As an implementation, the visiting frequency information of the person includes: the time interval between the latest visiting time of the person and the current time.

Therefore, the visiting frequency is characterized by the time interval between the latest visiting time and the current time. Exemplarily, if the time interval between the latest visiting time of the customer A and the current time is w, the visiting frequency of the customer A is w.

As an implementation, the visiting frequency information of the person includes: the number of visiting times of the person within the preset time period and the time interval between the latest visiting time of the person and the current time.

Therefore, the visiting frequency is characterized by the number of visiting times within the preset time period and the time interval between the latest visiting time and the current time. Exemplarily, if the number of visiting times of the customer A within the preset time period is y, and the time interval between the latest visiting time of the customer A and the current time is w, it is determined that the visiting frequency of the customer A is y & w.

In a possible implementation, before the visiting frequency information of the person is determined according to the historical visiting information corresponding to the person identity information, the method may further include the following operation.

Duplication eliminating processing is performed on the person identity information.

For example, a to-be-detected person identity information list within a time period is acquired, and person identity information corresponding to the same person in the to-be-detected person identity information list is filtered, such that the filtered person identity information included in the person identity information list corresponds to different persons respectively.

In some embodiments, before the visiting frequency information of the person is determined, whether the visiting frequency information of the person is determined within the second preset time period of the person is determined; if yes, the visiting frequency information of the person is no longer determined within the second preset time period; and if no, the visiting frequency information of the person is determined.

Therefore, the visiting frequency of the customer A is merely determined once within the second time period, thus avoiding the repeated calculation on the same visiting person within a period of time.

Exemplarily, if an image including the customer A is collected, before the visiting frequency of the A is determined, whether the visiting frequency of the customer A is determined within the second time period is determined; if the visiting frequency of the customer A is determined within the second time period, the visiting frequency of the customer A is no longer determined; and if the visiting frequency of the customer A is not determined within the second time period, the visiting frequency of the customer A is determined. Further, the operation that the visiting frequency information of the person is determined according to the historical visiting information corresponding to the person identity information may include the following operation.

The visiting frequency information of the person is determined according to historical visiting information corresponding to the person identity information obtained by the duplication eliminating processing.

Therefore, with the duplication eliminating processing, the unnecessary calculation can be reduced, and the system power consumption is saved.

In S104, label information of the person is determined based on the visiting frequency information of the person.

Herein, the label information is configured to characterize the visiting frequency of the person. For example, the label information includes a high frequency and a low frequency.

In some optional implementations, the operation that the label information of the person is determined based on the visiting frequency information of the person may include the following operation.

In response to that the number of visiting times of the target person within the preset time period is greater than or equal to a first threshold, it is determined that the label information of the target person indicates a high frequency.

Therefore, the label of the visiting person is determined according to the number of visiting times of the visiting person within the preset time period.

Exemplarily, if the number of visiting times of the customer A within the preset time period reaches to a certain value, the customer A is recorded as the high frequency.

In some optional implementations, the operation that the label information of the person is determined based on the visiting frequency information of the person may include the following operation.

The label information of the person is determined based on the visiting frequency information of the person and the identity type of the person.

As a result, the label of the visiting person can be determined in combination with the identity type of the visiting person.

In some optional implementations, the operation that the label information of the person is determined based on the visiting frequency information of the person and the identity type of the person may include the following operation.

In response to that the time interval between the latest visiting time of the person and the current time exceeds a second threshold, the label information of the person is determined based on the visiting frequency information of the person and the identity type of the person.

As a result, the label of the visiting person can be determined in combination with the identity type of the visiting person and the time interval between the latest visiting time and the current time.

In some optional embodiments, the operation that the label information of the person is determined based on the visiting frequency information of the person and the identity type of the person may include the following operations.

In response to that the time interval between the latest visiting time of the person and the current time exceeds the second threshold and the identity type of the person is the customer, it is determined that the label information of the person indicates a loss.

And/or, in response to that the time interval between the latest visiting time of the person and the current time exceeds the second threshold and the identity type of the person is the member, it is determined that the label information of the person indicates a deep sleep.

Exemplarily, if the identity type of the visiting person B is the customer, and the time interval between the latest visiting time of the visiting person B and the current time exceeds the second threshold, it is determined that the label of the visiting person B is in loss.

Exemplarily, if the identity type of the visiting person C is the member, and the time interval between the latest visiting time of the visiting person C and the current time exceeds the second threshold, it is determined that the label of the visiting person C is in deep sleep.

It is to be noted that the label may be set or adjusted as required by a user.

In a possible implementation, the method may further include the following operations.

Input label edition information is acquired, the label being user-defined.

The label set in the underlying database is adjusted based on the label edition information.

Exemplarily, the self-defined label includes a label defined based on a gender, such as a beauty and a handsome boy, and/or, includes a label defined based on a communication situation, such as having good communication and being relatively wordy.

Consequently, the label can be added or deleted as required by the customer, and it is convenient for the user to provide a customized service.

In a possible implementation, the method may further include the following operation.

The label information of the person is sent to a terminal device, such that the terminal device displays the label information of the person.

Therefore, a terminal user knows the personnel label of the current visiting person timely, makes a different reception according to the determined personnel label, and puts more customer reception energy and customer relationship maintenance energy onto the high-value customer selectively, thereby improving the sales conversion rate.

According to the technical solutions provided by the embodiment of the present disclosure, compared with poor accuracy and low efficiency of the existing manner that whether the visiting person is the new customer or the old customer is determined through naked eyes, the present disclosure can make an accurate determination on the new and old customers more quickly by means of the manner that whether the visiting person is the old customer by analyzing the feature of the collected image; and the present disclosure determines the visiting frequency of the visiting person by analyzing the historical visiting record, and determines the personnel label for the visiting person according the visiting frequency, such that the different reception is made according to the determined personnel label, and more customer reception energy and the customer relationship maintenance energy are selectively put onto the high-value customer, thereby improving the sales conversion rate.

The data processing method in the embodiment may be applied to a scenario in which the visiting person at a fixed place is analyzed. For instance, it is applied to analyzing the customer of the store or the company, or applied to analyzing the attendance of the employee in the company.

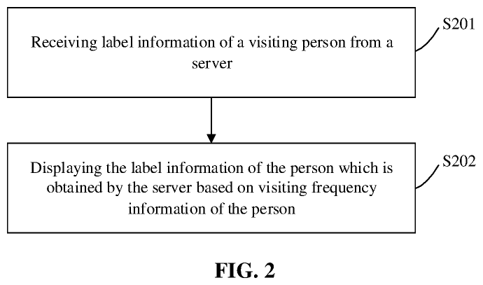

Based on the above data processing method, the embodiments of the present disclosure further provide a data processing method applied to a terminal. As shown in FIG. 2, the method may include the following steps.

In S201, label information of a visiting person that is sent by a server is received.

In S202, the label information of the person is displayed, the label information of the person being obtained by the server based on visiting frequency information of the person.

In a possible implementation, the operation that the label information of the person is displayed may include the following operation.

The label information of the person is displayed in a visiting notification interface for the person.

Therefore, a terminal user knows the personnel label of the current visiting person timely, makes a different reception according to the determined personnel label, and puts more customer reception energy and customer relationship maintenance energy onto the high-value customer selectively, thereby improving the sales conversion rate.

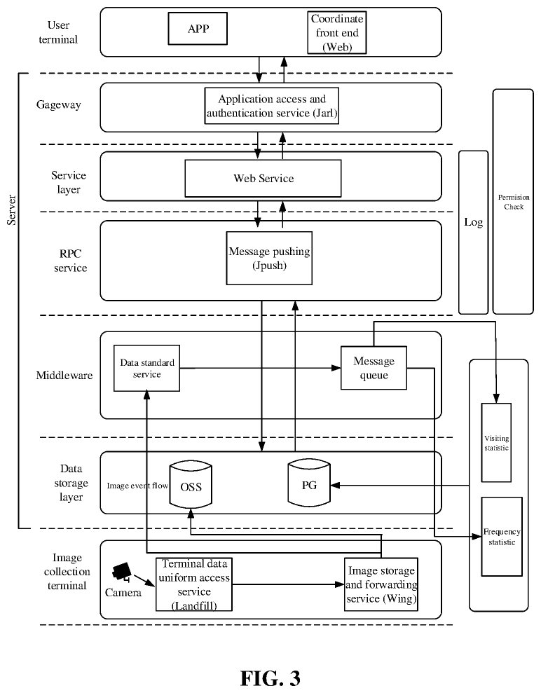

FIG. 3 is an exemplary architecture schematic diagram of a data processing system to which an embodiment of the present disclosure is applied. As shown in FIG. 3, the system includes an image collection terminal for collecting an image, a server terminal for determining a personnel label, and a user terminal for displaying and outputting the personnel label.

As an implementation, the server terminal includes a data storage layer configured to store historical visiting information, and a middleware for transmission.

As an implementation, a camera of the image collection terminal is configured to collect face and body data in an environment, the collected face and body data are first transmitted to a terminal data uniform access service (landfill) and then transmitted to an image storage and forwarding service (Wing) through a skyfall service; an image is forwarded to an Operation Support System (OSS) of the data storage layer of the server through the Wing; meanwhile, an image event flow is transmitted to a data standard service (Houng) of the middleware, data processed by Hound is transmitted to a Bifrost frame of the middleware and then transmitted to Kafka of the middleware; and data in a Kafka message queue is transmitted to a data analysis processing module of the server, thus completing visiting statistic and frequency statistic.

The user terminal installed with an Application (APP) and a coordinate front end (Web) is connected to a web service of a service layer of the server through an application access and authentication service (jarl) in the gateway, thereby connecting to a Remote Procedure Call (RPC) service. The RPC service acquires the historical visiting information from a Placement Group (PG) of the data storage layer to determine the label information of the visiting person; and through the RPC service, the label information of the visiting person is sent to the user terminal via message pushing (Jpush), so as to display the label information in the user terminal.

The RPC service includes a customer, a trace, visiting, an image pool and other logs.

It is to be noted and may be understood that the architecture shown in FIG. 3 is merely schematic, and may be set or adjusted according to a user requirement or a design requirement.

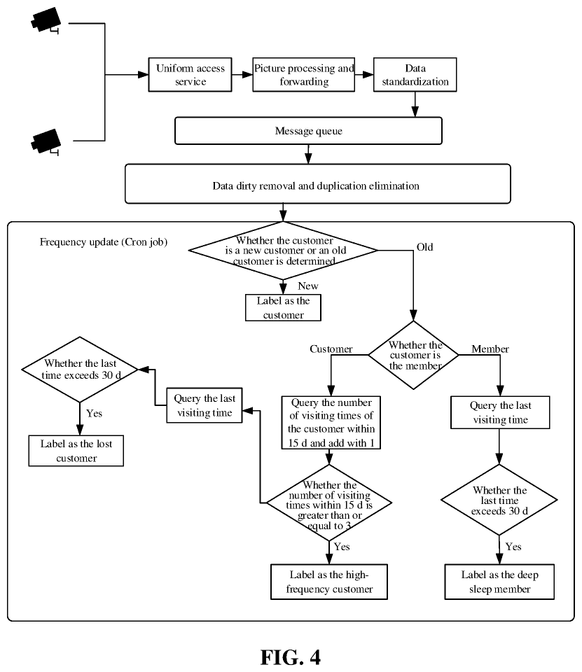

FIG. 4 is a flowchart schematic diagram illustrating that a personnel label is analyzed based on a visiting frequency. As shown in FIG. 4, the camera of the terminal processing layer is configured to collect a face image and a body image in an environment; the collected original image is transmitted to a picture processing and forwarding service through a uniform access service, feature extraction and indexing are performed on a face and a body through the picture processing and forwarding service, and obtained data is transmitted to a Kafka message queue through a data standard service for waiting for consumption; to-be-consumed data in the Kafka message queue is subjected to dirty removal and duplication eliminating processing through an invoking-retrieving service, and face and/or body feature data obtained after the dirty removal and duplication eliminating processing serve as a retrieval object to retrieve whether the existing database has data of the person, thereby determining whether the customer with the consumption at the current time is the old customer; if the customer is determined as the new customer, a customer label is given; and if the customer is determined as the old customer, whether analysis on different labels of the members is performed again is matched according to a static database. For example, it is specified in the method that the customer having the number of occurrence times within latest 15 d greater than or equal to 3 times is labeled as a high-frequency customer, the member having the latest arrival time greater than 30 days is labeled as a deep sleep member, and the store customer having the latest arrival time greater than 30 days is labeled as a lost customer. Specifically, if the customer is determined as the member, the last visiting time is queried, and whether the time towards the last visiting time exceeds 30 days is determined. When it is determined that the time exceeds 30 days, the customer is labeled as the deep sleep member, or otherwise, is not labeled. If the customer is not the member, i.e., the ordinary customer, the number of visiting times of the customer within 15 days is queried, the number of visiting times is added with 1, and then whether the number of visiting times within 15 days is greater than or equal to 3 is determined; if the number of visiting times is greater than or equal to 3, the customer is labeled as the high-frequency customer; if the number of visiting times within 15 days is smaller than 3, the last visiting time is queried, and whether the last visiting time exceeds 30 days is determined; and if the last visiting time exceeds 30 d, the customer is labeled as the lost customer.

It is to be noted and may be understood that the flowchart shown in FIG. 4 may be set or adjusted according to a user requirement or a design requirement. Each determination parameter applied in FIG. 4, such as 30 days, 15 days and 3 times, may be set or adjusted in combination with the user requirement or the design requirement. The above content is not limited thereto.

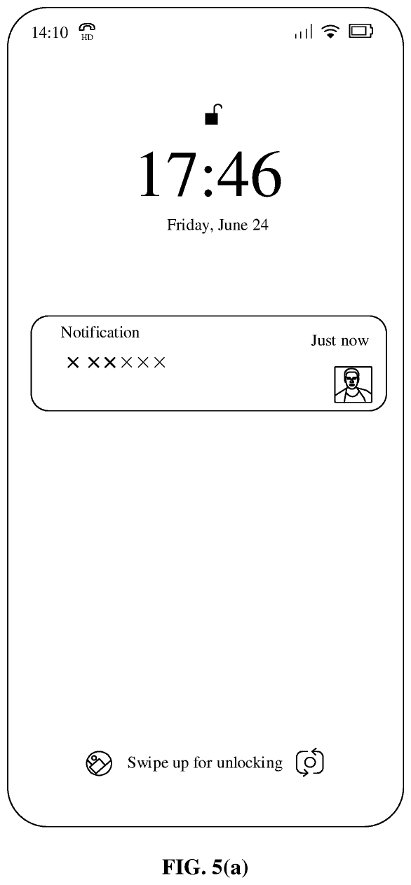

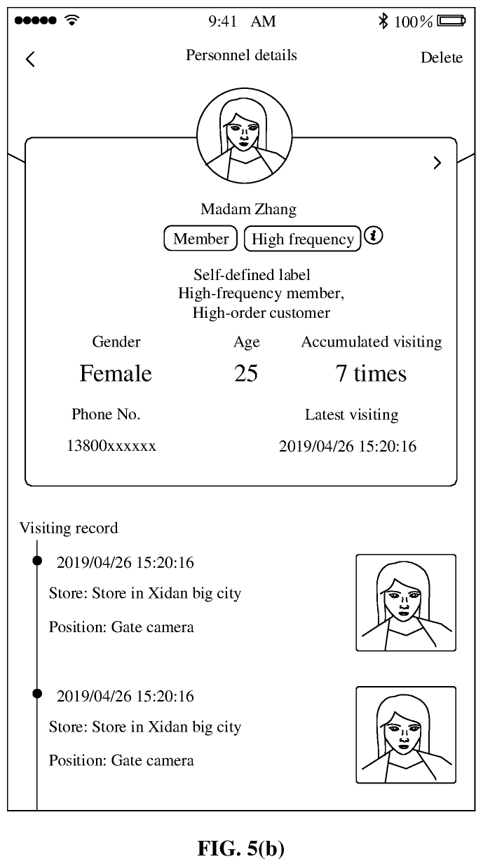

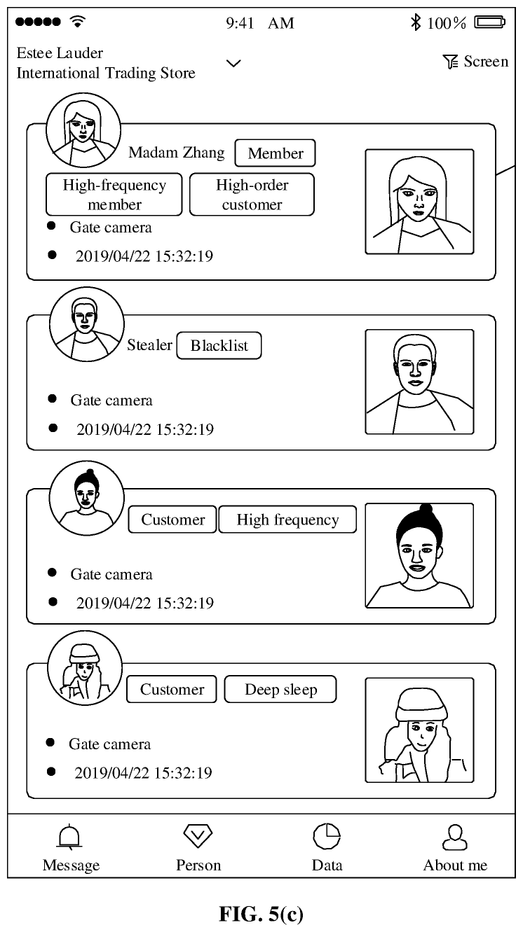

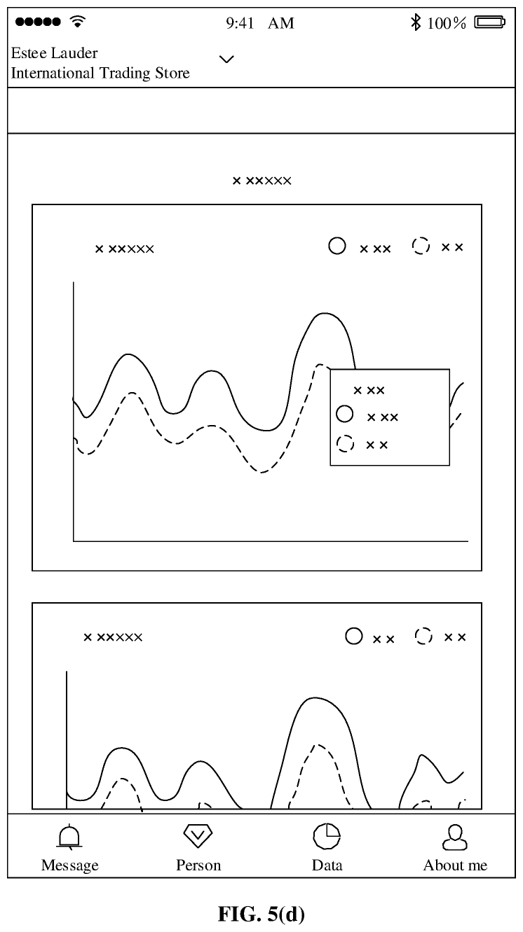

FIG. 5(a) is a schematic diagram illustrating that a terminal receives a visiting message for pushing. The store salesman may query, by receiving a pushed visiting message of the member in real time, the identity and the label of the customer, and provide the high-quality reception for the customer at the first time. Moreover, the store security personnel determines a blacklist person and a position thereof by receiving a pushed blacklist alarm message in real time, thereby eliminating the risk efficiently. FIG. 5(b) is a schematic diagram illustrating that a historical visiting message of a consumer is queried. By displaying the historical visiting record of the customer at the terminal side, the great convenience is provided for the salesman to distinguish and recall key point information in the historical reception and sales process, and accumulate to the latest visiting times through the system, thereby supporting to determine the purchase intention and the value of the customer. Therefore, not only the customer marketing skills of the salesman are improved, but also the sales conversion rate is improved. FIG. 5(c) is a schematic diagram illustrating that a system displayed at a terminal side automatically displays a multidimensional identity label. As the system supports the customer classification based on the label, the manager and the salesman in the store may provide targeted customer marketing and customer operation for the customer under the label. FIG. 5(d) is a data analysis schematic diagram obtained by a visiting person in a time period. After scanning the system, the manager in the store may master customer base analysis data and customer flow tendency data of the store, such as a comparison diagram between the total customer flow volume and the member visiting amount, and a comparison diagram between new and old customers. If the trading data is combined, the help can be provided for the manager to analyze and locate the current marketing and operation problem, thus providing the basis for improving the sales position and designing the marketing activity in a next stage.

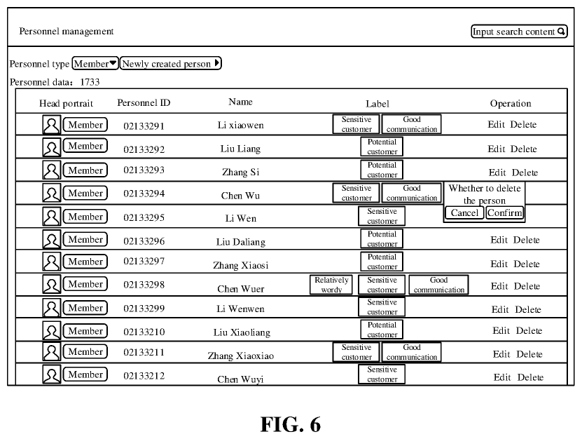

FIG. 6 is a schematic diagram of an edition interface of a personnel label. The user may edit the interface. As shown in FIG. 6, the user may manage the visiting person through the interface. For example, the identity type of the visiting person is the member. On the interface, a head portrait, a personnel ID, a name, a label, an operation item and other items of each member are displayed. The user may edit each member by clicking an edit button corresponding to the operation item, for example, the user selects the label considered as being suitable for the member from an optional label database, or defines the label for some member, etc. The user may further delete, through a delete button corresponding to the operation item, the member considered as being handled with the membership withdrawal procedures or being low in value.

Exemplarily, the personnel display interface of the terminal displays, upon the reception of an operation input by the user to search a specified person, a brief introduction interface of the specified person, the label of the specified person being displayed on the interface; displays, upon the reception of an operation input by the user to enter a detailed page of the person, a detailed introduction interface of the specified person, a historical visiting record of the specified person being displayed on the interface; and edits, upon the reception an operation input by the user to edit the self-defined label of the person, the label of the specified person based on the edit operation of the user.

Exemplarily, on the personnel display interface of the terminal, label information of multiple people is displayed on the personnel interface; when an operation input by the user to slide one person leftward or rightward in the interface is received, the label of the person is in an editable state; and when edition information input by the user is received, the label of the person is edited based on the edition information input by the user.

Exemplarily, on the personnel display interface of the terminal, when an operation input by the user to pull up a scroll bar on the interface is received, the terminal updates a personnel list displayed on the current interface; when finding the customer of the specified store at the specified date on the current interface, the user clicks the operation to enter the detailed page of the person; and when receiving an operation input by the user to convert the customer into the member, the user changes the identity type of the person from the customer into the member based on the operation.

It is to be noted and may be understood that the above process is merely schematic. In actual application, different setting operations may be provided for the user to implement the above different functions.

The camera collects the image, and transmits the collected image to the server, such that the server identifies the image to obtain the face and/or body feature of the person included in the image, and obtains, based on the face and/or body feature, the person identity information of the person included in the image; the historical visiting information corresponding to the person identity information is acquired; the visiting frequency information of the person is determined according to the historical visiting information corresponding to the person identity information; and the label information of the person is determined based on the visiting frequency information of the person. The server transmits the determined label information of the person to the user terminal installed with the APP, such that the user terminal displays the label information of the person. Therefore, the terminal user makes a different reception according to the determined personnel label, and puts more customer reception energy and customer relationship maintenance energy onto the high-value customer selectively, thereby improving the sales conversion rate.

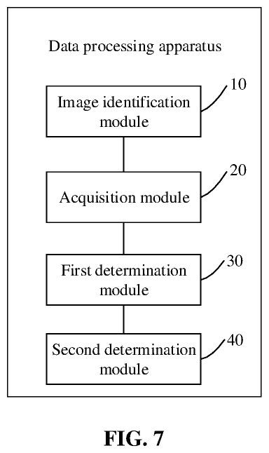

The embodiments of the present disclosure further provide a data processing apparatus. As shown in FIG. 7, the apparatus may include: an image identification module 10, an acquisition module 20, a first determination module 30 and a second determination module 40.

The image identification module 10 is configured to perform image identification processing on an acquired image to obtain person identity information of a person included in the image.

The acquisition module 20 is configured to acquire historical visiting information corresponding to the person identity information.

The first determination module 30 is configured to determine visiting frequency information of the person according to the historical visiting information corresponding to the person identity information.

The second determination module 40 is configured to determine label information of the person based on the visiting frequency information of the person.

As an implementation, the acquisition module 20 may include: a determination unit and an acquisition unit.

The determination unit is configured to determine an identity type corresponding to the person identity information, the identity type including at least one of a member or a customer.

The acquisition unit is configured to acquire the historical visiting information corresponding to the person identity information based on the identity type corresponding to the person identity information.

As an implementation, the acquisition unit is configured to:

acquire, in response to that the identity type of the person is the customer, historical visiting information of the person, who corresponds to the person identity information, at a current visiting place.

As an implementation, the acquisition unit is configured to:

acquire, in response to that the identity type of the person is the member, historical visiting information of the person, who corresponds to the person identity information, in at least a part of places in a set to which a current visiting place belongs.

In a possible implementation, the visiting frequency information of the person includes at least one of: the number of visiting times of the person within a preset time period and a time interval between the latest visiting time of the person and current time.

As an implementation, the second determination module 40 is configured to:

determine, in response to that the number of visiting times of the target person within the preset time period is greater than or equal to a first threshold, that the label information of the target person indicates a high frequency.

As an implementation, the second determination module 40 is configured to:

determine the label information of the person based on the visiting frequency information of the person and the identity type of the person.

As an implementation, the second determination module 40 is configured to:

determine, in response to that the time interval between the latest visiting time of the person and the current time exceeds a second threshold, the label information of the person based on the visiting frequency information of the person and the identity type of the person.

As an implementation, the second determination module 40 is configured to:

determine, in response to that the time interval between the latest visiting time of the person and the current time exceeds the second threshold and the identity type of the person is the customer, that the label information of the person indicates a loss; and/or

determine, in response to that the time interval between the latest visiting time of the person and the current time exceeds the second threshold and the identity type of the person is the member, that the label information of the person indicates a deep sleep.

In a possible implementation, the apparatus may further include: a duplication eliminating module 50.

The duplication eliminating module 50 (not shown in FIG. 7) is configured to perform duplication eliminating processing on the person identity information before the second determination module 40 determines the visiting frequency information of the person according to the historical visiting information corresponding to the person identity information.

The second determination module 40 is configured to:

determine the visiting frequency information of the person according to historical visiting information corresponding to person identity information that is obtained by the duplication eliminating processing.

As an implementation, the image identification module 10 is configured to:

process the acquired image to determine whether an underlying database includes an image template matching with the person included in the image; and

take, in response to that the underlying database has the image template matching with the person, person identity information corresponding to the matched image template as the person identity information of the person.

As an implementation, the image identification module 10 is configured to:

create, in response to that the underlying database does not have the image template matching with the person, an image template corresponding to the person in the underlying database, and allocate a new person identity to the person.

In a possible implementation, the apparatus may further include: a communication module 60.

The communication module 60 (not shown in FIG. 7) is configured to send the label information of the person to a terminal device, such that the terminal device displays the label information of the person.

As an implementation, the acquisition module 20 is further configured to:

determine, before acquiring the historical visiting information corresponding to the person identity information, whether the historical visiting information corresponding to the person identity information is acquired within a second preset time period of the person; no longer acquire, if yes, the historical visiting information corresponding to the person identity information within the second preset time period; and acquire, if no, the historical visiting information corresponding to the person identity information.

In a possible implementation, the apparatus may further include: a setting module 70.

The setting module 70 (not shown in FIG. 7) is configured to:

acquire input label edition information, the label being user-defined; and

adjust a label set in the underlying database based on the label edition information.

Those skilled in the art should understand that, in some optional embodiments, functions realized by each processing module in the data processing apparatus shown in FIG. 7 may be understood with reference to related descriptions about the data processing method.

It is to be understood by those skilled in the art that, in some optional embodiments, the functions of each processing unit in the data processing apparatus shown in FIG. 7 may be realized through a program running in a processor, and may also be realized through a specific logical circuit.

In actual application, the specific structures of the image identification module 10, the acquisition module 20, the first determination module 30, the second determination module 40, the duplication eliminating module 50, the communication module 60 and the setting module 70 may correspond to the processor. The specific structure of the processor may be an electronic component having a processing function such as a Central Processing Unit (CPU), a Micro Controller Unit (MCU), a Digital Signal Processing (DSP) or a Programmable Logic Controller (PLC) or a set of the electronic component. The processor includes an executable code; the executable code is stored in a storage medium; and the processor may be connected to the storage medium through a communication interface such as a bus, and reads, when executing a specific corresponding function of each unit, the executable code from the storage medium and runs the executable code. The part of the computer storage medium for storing the executable code is a non-instantaneous storage medium.

According to the data processing apparatus provided by the embodiment of the present disclosure, the visiting frequency of the visiting person is determined by analyzing the historical visiting record, and the personnel label is determined for the visiting person according the visiting frequency, such that the different reception is made according to the determined personnel label, and more customer reception energy and the customer relationship maintenance energy are selectively put onto the high-value customer, thereby improving the sales conversion rate.

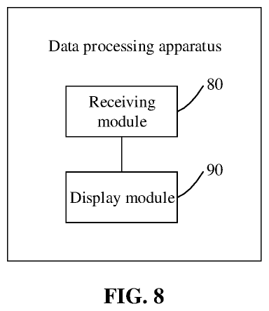

The embodiments of the present disclosure further provide a data processing apparatus, which is applied to a terminal. As shown in FIG. 8, the apparatus may include: a receiving module 80 and a display module 90.

The receiving module 80 is configured to receive label information of a visiting person that is sent by a server.

The display module 90 is configured to display the label information of the person.

The label information of the person is obtained by the server based on visiting frequency information of the person.

In some optional implementations, the display module 90 is configured to:

display the label information of the person in a visiting notification interface for the person.

Those skilled in the art should understand that, in some optional embodiments, functions realized by each processing module in the data processing apparatus shown in FIG. 8 may be understood with reference to related descriptions about the data processing method.

It is to be understood by those skilled in the art that, in some optional embodiments, the functions of each processing unit in the data processing apparatus shown in FIG. 8 may be realized through a program running in a processor, and may also be realized through a specific logical circuit.

In actual application, the specific structures of the receiving module 80 and the display module 90 may correspond to the processor. The specific structure of the processor may be an electronic component having a processing function such as a CPU, an MCU, a DSP or a PLC or a set of the electronic component. The processor includes an executable code; the executable code is stored in a storage medium; and the processor may be connected to the storage medium through a communication interface such as a bus, and reads, when executing a specific corresponding function of each unit, the executable code from the storage medium and runs the executable code. The part of the computer storage medium for storing the executable code is a non-instantaneous storage medium.

According to the data processing apparatus provided by the embodiment of the present disclosure, a terminal user knows the personnel label of the current visiting person timely, makes a different reception according to the determined personnel label, and puts more customer reception energy and customer relationship maintenance energy onto the high-value customer selectively, thereby improving the sales conversion rate.

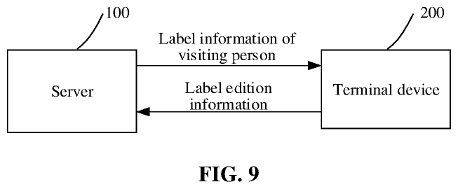

An interaction schematic diagram between a server and a terminal device may be referred to FIG. 9. As shown in FIG. 9, the server 100 is configured to perform image identification processing on an acquired image to obtain person identity information of a person included in the image; acquire historical visiting information corresponding to the person identity information; determine visiting frequency information of the person according to the historical visiting information corresponding to the person identity information; determine label information of the person based on the visiting frequency information of the person; and send the label information of the person to the terminal device 200; and the terminal device 200 is configured to receive the label information of the visiting person that is sent by the server 100; and display the label information of the person.

In some embodiments, the terminal device 200 is configured to acquire label edition information input by a user, the label being user-defined; and send the label edition information to the server 100; and the server 100 is configured to adjust a label set in an underlying database based on the label edition information.

The embodiments of the present disclosure provide a data processing apparatus, which may include: a memory, a processor, and a computer program stored on the memory and capable of running on the processor; and the processor implements, when executing the program, the steps of the data processing method in the embodiments of the present disclosure.

The embodiments of the present disclosure provide a storage medium; the storage medium stores a computer program; and the computer program causes, when executed by a processor, the processor to execute the steps of the data processing method in the embodiments of the present disclosure.

Those skilled in the art should understand that functions of each program in the computer storage medium in the embodiment may be understood with reference to related descriptions about the data processing method in the above embodiments. The computer storage medium may be a volatile computer-readable storage medium or a non-volatile computer-readable storage medium.

The embodiments of the present disclosure further provide a computer-readable code; and when the computer-readable code runs in a device, a processor in the device executes the data processing method provided by the above any embodiment.

The computer program product may be specifically implemented through hardware, software or a combination thereof. In an optional embodiment, the computer program product is specifically embodied as a computer storage medium; and in another embodiment, the computer program product is specifically embodied as a software product, such as a Software Development Kit (SDK).

Those skilled in the art should understand that functions of each program in the computer storage medium in the embodiment may be understood with reference to related descriptions about the data processing method in the above embodiments.

It is further to be understood that each optional embodiment set forth in the specification is merely schematic, and is intended to help those skilled in the art to better understand the technical solutions in the embodiments of the present disclosure but should not be understood as limiting the embodiment of the present disclosure. Those of ordinary skill in the art may make various changes and replacements on the basis of the optional embodiments of the present disclosure, and these changes and replacements should also be understood as a part of the embodiments of the present disclosure.

Additionally, in the present disclosure, the descriptions about the technical solutions are made with emphasis on differences between each embodiment and the same or similar parts may refer to each other and will not be elaborated for simplicity.

In the several embodiments provided in the disclosure, it should be understood that the disclosed device and method may be implemented in other manners. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each function unit in each embodiment of the present disclosure may be integrated into a processing unit, each unit may also exist independently, and two or more than two unit may also be integrated into a unit. The integrated unit may be implemented in a hardware form, and may also be implemented in form of hardware and software function unit.

Those of ordinary skill in the art should know that: all or part of the steps of the abovementioned method embodiment may be implemented by instructing related hardware through a program, the abovementioned program may be stored in a computer-readable storage medium, and the program is executed to execute the steps of the abovementioned method embodiment; and the storage medium includes: various media capable of storing program codes such as mobile storage equipment, a Read-Only Memory (ROM), a Random Access Memory (RAM), a magnetic disk or an optical disc.

Or, when being implemented in form of software function module and sold or used as an independent product, the integrated unit of the present disclosure may also be stored in a computer-readable storage medium. Based on such an understanding, the technical solutions of the embodiments of the present disclosure substantially or parts making contributions to the conventional art may be embodied in form of software product, and the computer software product is stored in a storage medium, including a plurality of instructions configured to enable a piece of computer equipment (which may be a personal computer, a server, network equipment or the like) to execute all or part of the method in each embodiment of the disclosure. The abovementioned storage medium includes: various media capable of storing program codes such as mobile storage equipment, a ROM, a RAM, a magnetic disk or an optical disc.

The above is only the specific implementation of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subjected to the scope of protection of the claims.

### INDUSTRIAL APPLICABILITY

According to the technical solutions provided by the embodiment of the present disclosure, the image identification processing is performed on the acquired image to obtain the person identity information of the person included in the image; the historical visiting information corresponding to the person identity information is acquired; the visiting frequency information of the person is determined according to the historical visiting information corresponding to the person identity information; and the label information of the person is determined based on the visiting frequency information of the person. Therefore, the present disclosure is convenient to provide a targeted service for a customer based on a label of the customer, thereby improving the customer experience and the sales conversion rate.

1. A method of data processing, comprising:
performing image identification processing on an acquired image to obtain person identity information of a person comprised in the image;
acquiring historical visiting information corresponding to the person identity information;
determining visiting frequency information of the person according to the historical visiting information corresponding to the person identity information; and
determining label information of the person based on the visiting frequency information of the person.

2. The method of claim 1, wherein acquiring the historical visiting information corresponding to the person identity information comprises:
determining an identity type corresponding to the person identity information, the identity type comprising at least one of a member or a customer; and
acquiring the historical visiting information corresponding to the person identity information based on the identity type corresponding to the person identity information.

3. The method of claim 2, wherein acquiring the historical visiting information corresponding to the person identity information based on the identity type corresponding to the person identity information comprises:
in response to that the identity type of the person is the customer, acquiring historical visiting information of the person, who corresponds to the person identity information, at a current visiting place.

4. The method of claim 2, wherein acquiring the historical visiting information corresponding to the person identity information based on the identity type corresponding to the person identity information comprises:
in response to that the identity type of the person is the member, acquiring historical visiting information of the person, who corresponds to the person identity information, in at least a part of places in a set to which a current visiting place belongs.

5. The method of claim 1, wherein the visiting frequency information of the person comprises at least one of: the number of visiting times of the person within a preset time period, and a time interval between the latest visiting time of the person and current time.

6. The method of claim 1, wherein determining the label information of the person based on the visiting frequency information of the person comprises:
in response to that the number of visiting times of the person within a preset time period is greater than or equal to a first threshold, determining that the label information of the person indicates a high frequency.

7. The method of claim 1, wherein determining the label information of the person based on the visiting frequency information of the person comprises:
determining the label information of the person based on the visiting frequency information of the person and an identity type of the person.

8. The method of claim 7, wherein determining the label information of the person based on the visiting frequency information of the person and the identity type of the person comprises:
in response to that a time interval between the latest visiting time of the person and current time exceeds a second threshold, determining the label information of the person based on the visiting frequency information of the person and the identity type of the person.

9. The method of claim 7, wherein determining the label information of the person based on the visiting frequency information of the person and the identity type of the person comprises at least one of:
in response to that a time interval between the latest visiting time of the person and current time exceeds a second threshold and the identity type of the person is a customer, determining that the label information of the person indicates a loss; or
in response to that the time interval between the latest visiting time of the person and the current time exceeds the second threshold and the identity type of the person is a member, determining that the label information of the person indicates a deep sleep.

10. The method of claim 1, before determining the visiting frequency information of the person according to the historical visiting information corresponding to the person identity information, further comprising:
performing duplication eliminating processing on the person identity information; and
determining the visiting frequency information of the person according to the historical visiting information corresponding to the person identity information comprises:
determining the visiting frequency information of the person according to historical visiting information corresponding to person identity information that is obtained by the duplication eliminating processing.

11. The method of claim 1, wherein performing the image identification processing on the acquired image to obtain the person identity information of the person comprised in the image comprises:
processing the acquired image to determine whether an underlying database comprises an image template matching with the person comprised in the image; and
in response to that the underlying database has the image template matching with the person, taking person identity information corresponding to the matched image template as the person identity information of the person.

12. The method of claim 11, wherein performing the image identification processing on the acquired image to obtain the person identity information of the person comprised in the image further comprises:
in response to that the underlying database does not have the image template matching with the person, creating an image template corresponding to the person in the underlying database, and allocating a new person identity to the person.

13. The method of claim 1, further comprising:
sending the label information of the person to a terminal device, such that the terminal device displays the label information of the person.

14. A method of data processing, applied to a terminal and comprising:
receiving label information of a visiting person from a server; and
displaying the label information of the person,
wherein the label information of the person is obtained by the server based on visiting frequency information of the person.

15. The method of claim 14, wherein displaying the label information of the person comprises:
displaying the label information of the person in a visiting notification interface for the person.

16. An apparatus of data processing, comprising:
a memory, a processor, and a computer program stored on the memory and capable of running on the processor,
wherein the processor is configured to execute the program to:
perform image identification processing on an acquired image to obtain person identity information of a person comprised in the image;
acquire historical visiting information corresponding to the person identity information;
determine visiting frequency information of the person according to the historical visiting information corresponding to the person identity information; and
determine label information of the person based on the visiting frequency information of the person.

17. The apparatus of claim 16, wherein the processor is further configured to execute the program to:
determine an identity type corresponding to the person identity information, the identity type comprising at least one of a member or a customer; and
acquire the historical visiting information corresponding to the person identity information based on the identity type corresponding to the person identity information.

18. The apparatus of claim 17, wherein the processor is further configured to execute the program to:
acquire, in response to that the identity type of the person is the customer, historical visiting information of the person, who corresponds to the person identity information, at a current visiting place.

19. The apparatus of claim 17, wherein the processor is further configured to execute the program to:
acquire, in response to that the identity type of the person is the member, historical visiting information of the person, who corresponds to the person identity information, in at least a part of places in a set to which a current visiting place belongs.

20. The apparatus of claim 16, wherein the visiting frequency information of the person comprises at least one of: the number of visiting times of the person within a preset time period and a time interval between the latest visiting time of the person and current time.
